(19) United States
(12) Patent Application Publication
(10) Pub. No.: US 2021/0097413 A1
(43) Pub. Date: Apr. 1, 2021

(54) Predictive Readiness and Accountability Management

(71) Applicants: Terrence Nevins, Lynnwood, WA (US); David Young, Bellevue, WA (US); Doug de la Torre, Bellevue, WA (US)

(72) Inventors: Terrence Nevins, Lynnwood, WA (US); David Young, Bellevue, WA (US); Doug de la Torre, Bellevue, WA (US)

(21) Appl. No.: 17/106,149

(22) Filed: Nov. 29, 2020

Related U.S. Application Data
(60) Provisional application No. 62/907,688, filed on Sep. 29, 2019.

(51) Int. Cl. G06N 5/04; G06N 20/00

(52) U.S. Cl. CPC G06N 5/04; G06N 20/00

(57) ABSTRACT

A system and method for predictive readiness and accountability management may provide improved techniques for tracking and predicting a trajectory of an item that may comprise a piece of equipment, an item of inventory, a task for a company project, or a piece of data example. The system may incorporate machine learning to gather data, track trends, or provide alerts, reminders, feedback, or recommendations.

### FIELD

This disclosure relates generally to predictive readiness and accountability management.

### BACKGROUND

Entities such as businesses or military branches are responsible for managing billions of dollars' worth of equipment, inventory, personnel, or data, among other things. A lapse in readiness or accountability by one or more parties can significantly harm productivity, profits, or national security.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, a system and method for predictive readiness and accountability management. In one implementation, it may comprise improved techniques for tracking and predicting a trajectory of an item, which may comprise a piece of equipment, an item of inventory, a task for a company project, or a piece of data, for example. Predictive readiness and accountability management may link an item identifier to an accountable party and input the item identifier, accountable party, a geocode, other data, and a set of rules into a database. The system may continuously update the database, determine rule violations, and issue alerts, reminders, feedback, or recommendations, such as when the item exceeds a boundary or lags behind schedule. The system may incorporate machine learning to gather data about items, parties, locations, trends such as high traffic times, behavioral patterns, or other data. In one implementation, the system may provide a graphical user interface (GUI) operable to display promotions or discounts from third-party vendors or other information.

Predictive readiness and accountability management may integrate into practical applications of project, workflow, personnel, equipment, inventory, or data management. Systems and methods disclosed herein may enable improvements in communication, prediction, or management of a flow of goods, services, or behaviors that may affect an entity or individual's readiness or accountability, among other benefits.

Many of the attendant features may be more readily appreciated as they become better understood by reference to the following detailed description considered in connection with the attached drawings.

### BRIEF DESCRIPTION OF THE DRAWINGS

FIG. 1 is an example of a flow diagram operable to support a predictive readiness and accountability management system, according to one implementation.

FIG. 2 is a block diagram with components that may be used in a predictive readiness and accountability and management system, according to one implementation.

FIG. 3 is a block diagram illustrating an example of a system capable of supporting a predictive readiness and accountability management system.

FIG. 4 is a component diagram of a computing device that may support a predictive readiness and accountability and management system, according to one implementation.

### DETAILED DESCRIPTION

Many of the attendant features may be more readily appreciated as they become better understood by reference to the following detailed description considered in connection with the attached drawings, in which like parts are assigned like numerals.

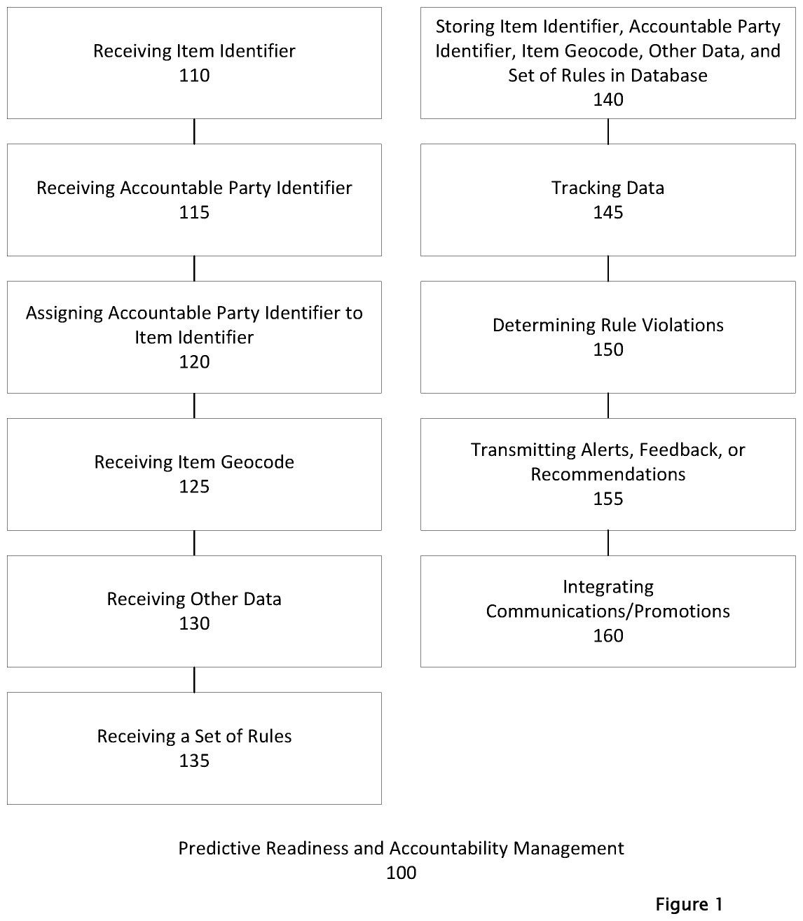

FIG. 1 is an example of Predictive Readiness and Accountability Management 100 flow diagram, according to one implementation. At Receiving Item Identifier 110, the system may receive information such as a serial number, barcode, name, make, model, manufacturer, or other description relating to an item. The item may comprise anything tangible or intangible, for example, a piece of equipment, an item of inventory, an employee identification number, a task for a company project, or a piece of data.

At Receive Accountable Party Identifier 115, the system may receive information regarding an entity or individual who may have a past, present, or future responsibility for any part of the item identified in step 110. For example, an accountable party identifier may comprise a name or identification number of a military service member to whom a jacket liner or weapon is assigned while on deployment, or a name of a team of employees assigned to complete a task for a company project.

At Assigning Accountable Party Identifier to Item Identifier 120, the system may link the item identified in step 110 to a party that may have an actual or potential responsibility for the item. At Receiving Item Geocode 125, the system may continuously receive information regarding a location of the item, for example, global positioning system (GPS) coordinates of the item at various geographic locations. In another implementation, the geocode may comprise a non-geographic or virtual location, for example, a step or task in a project or workflow, or a piece of data in a data stream.

At Receiving Other Data 130, the system may receive various data from any source. For example, a user of a mobile device may capture a photo, video, text, measurement, or other information related to the item, the accountable party, the geocode, or other data. For example, a military service member may use a mobile device to take a photo of a jacket liner or weapon assigned to that service member before leaving for deployment. The service member may supplement the photo with text or other information such as color, weight, condition, maintenance requirements, or other attributes regarding the item.

At Receiving a Set of Rules 135, the system may receive one or more rules regarding the item, accountable party, geocode, or other data. For example, a rule may define boundaries or limits beyond which the item or accountable party may be prohibited from exceeding, or it may define a checklist or schedule for a completion of tasks. The system may incorporate machine learning to receive or recommend rules based on data collected.

At Storing Item Identifier, Accountable Party Identifier, Item Geocode, Other Data, and Set of Rules in Database 140, the system may input various data received into a database. At Tracking Data 145, the system may continuously receive and update the database with new data, such as an updated condition or location of an item or a new accountable party, for example. In one implementation, the system may perform steps of filtering, sorting, ranking, or weighting the data. Older pieces of data may also be stored or referenced.

At Determining Rule Violations 150, the system may determine whether a rule identified in step 135 has been violated. For example, the system may determine whether an item became damaged, lost, destroyed, whether the item became possessed by a non-permitted party, or whether it exceeded a boundary or time limitation in violation of a rule.

At Transmitting Alerts, Feedback, or Recommendations 155, the system may communicate updated information regarding the item, accountable party, or other data to an end-user or an interested party. For example, the system may transmit a due date reminder, a delay or overdue notice, an inspection or maintenance reminder, an update regarding a location of an item, an alert that the item has become damaged or lost, or a notification that an item has been returned or completed. The alerts, feedback, or recommendations may include photos, videos, text, measurements, or other information from any source.

At Integrating Communications/Promotions 160, the system may enable a communication module to transmit additional information, which may comprise advertisements or discounts for goods or services from third-party vendors, or other information from any source which may have either for-profit or non-profit purposes.

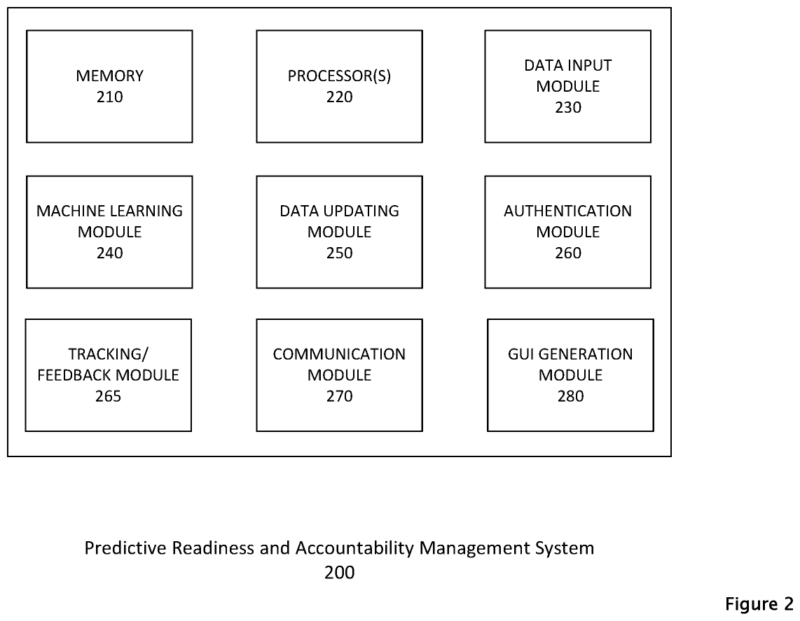

FIG. 2 is a block diagram with components that may be used in a predictive readiness and accountability and management system, according to one implementation. Predictive Readiness and Accountability Management System 200 may include Memory 210, one or more Processor(s) 220, Data Input Module 230, Machine Learning Module 240, Data Updating Module 250, Authentication Module 260, Communication Module 270, and Graphical User Interface (GUI) Generation Module 280.

Memory 210 may be any device, mechanism, or populated data structure used for storing information. Memory 210 may be used to store instructions for running one or more applications or modules on Processor(s) 220. For example, Memory 210 may be used in one or more implementations to house all or some of the instructions needed to execute a functionality of Data Input Module 230, Machine Learning Module 240, Data Updating Module 250, Authentication Module 260, Tracking/Feedback Module 265, Communication 270, or Graphical User Interface (GUI) Generation Module 280.

Data Input Module 230 may enable the system to receive data such as a serial number, barcode, name, make, model, manufacturer, or any other information relating to an item. The item may be tangible or intangible, such as a piece of equipment, an inventory item, an employee identification number, a task for a company project, or a piece of data. For example, the item may comprise a jacket liner or a weapon issued by a military branch to an entrusted service member upon deployment. Data Input Module 230 may also enable the system to receive a name of an accountable party, a geocode, or other information, for example, a condition or maintenance requirements of an item. In one implementation, a user may input data using a software application on a mobile device. In another implementation, a user may input data at a stationary kiosk, which may or may not be connected to a wireless or cellular network. In yet another implementation, data may be received or input from any source.

Predictive Readiness and Accountability Management 200 may incorporate Machine Learning Module 240 or artificial intelligence (AI) to receive and improve upon data related to an item, an accountable party, an item geocode, or other data. Machine Learning Module 240 may use pattern matching or pattern recognition to identify a person or object in a photo or video in one implementation. For example, it may identify a service member who completed a training or a piece of military equipment that should be taken out of service. Machine Learning Module 240 may refer to patterns, logs, comparisons, time slices, or other data sources. Machine Learning Module 240 may be used to predict high traffic times or wait times, recommend a checklist, recommend a schedule, recommend a course of action, or achieve any other function.

Data Updating Module 250 may continuously update the database with new or relevant information. Authentication Module 260 may authorize or restrict access to data. For example, it may enable an alert to be issued when an unauthorized party attempts to gain access to a weapon or when a worker tries to send out a piece of faulty equipment.

Communication Module 270 may enable display of information such as advertisements or discounts for goods or services from third-party vendors, or other information. It may provide a feedback loop to keep military leaders, service members, or their families informed of current events or other issues in one implementation. Recent privatization of on-base housing has relocated many service members off military bases. This has made communication and accessibility for health and wellness checks, for example, more difficult. Predictive Readiness and Accountability Management System 200 may help improve communications, support readiness or accountability, or boost morale among military communities, or other demographics.

For example, Communication Module 270 may transmit notifications regarding whether a service member has satisfied readiness requirements for deployment, such as a fitness test, training, legal paperwork, or updates regarding a service member's medication condition or deployment schedule. In another example, Communication Module 270 may provide service members with information regarding best practices for safety or efficiencies. In yet another example, service members or their families may gain access to discounts from local businesses whose sponsorship of military programs may benefit a family welfare fund.

Communication Module 270 may display information via a graphical user interface (GUI) on a mobile device application, a website, a blog, a static or pop-up advertisement, or a stationary kiosk, for example. Graphical User Interface (GUI) Generation Module 280 may be operable to display a user interface in various settings. In one implementation, access to information may be segmented into a plurality of channels, for example, a family channel and a unit command channel with different permissions.

Predictive Readiness and Accountability Management System 200 may include or access a database having stored therein a plurality of data received from user inputs, or other information. Authentication Module 260 may access the database, or another database, to facilitate predictive readiness and accountability management. In another implementation, the system may include an application programming interface (API) server, which may be operable to receive information about predictive readiness and accountability management.

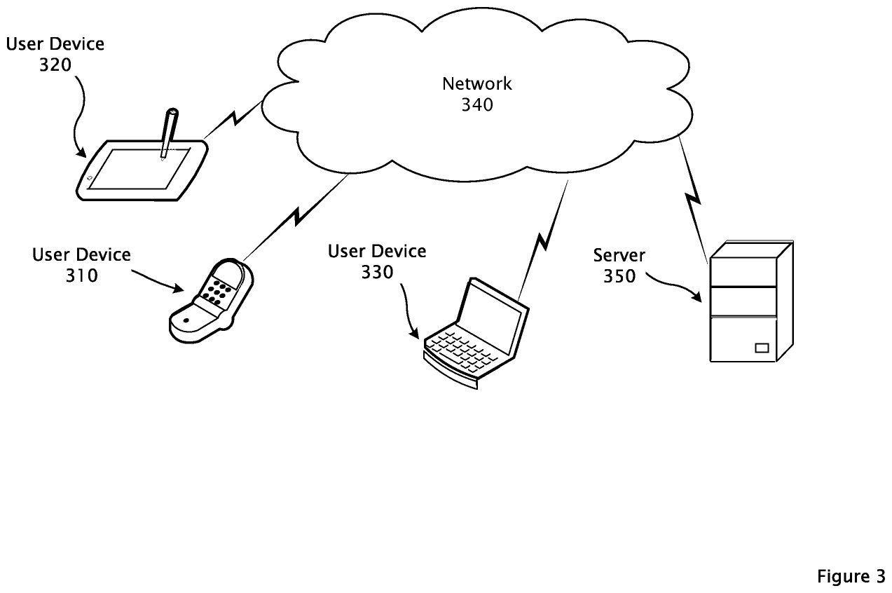

FIG. 3 is a block diagram illustrating an example of a system capable of supporting a predictive readiness and accountability management system, according to one implementation. Network 340 may include Wi-Fi, cellular data access methods, such as 3G, 4G LTE, 5G, Bluetooth, Near Field Communication (NFC), the Internet, local area networks, wide area networks, or any combination of these or other means of providing data transfer capabilities. In one implementation, Network 340 may comprise Ethernet connectivity. In another implementation, Network 340 may comprise fiber-optic connections.

User Device 310, 320, or 330 may be a smartphone, tablet, laptop computer, smartwatch, intelligent eyewear, or other devices. It may have location-based services, for example, GPS, cell phone tower triangulation capability, or accelerometers, and may have network capabilities to communicate with Server 350. Server 350 may include one or more computers and may serve a number of roles. Server 350 may be conventionally constructed or may be of a special purpose design for processing data obtained from a predictive readiness and accountability management system. An entity or individual using a predictive readiness and accountability management system may use a server owned or managed by a service provider. One skilled in the art will recognize that Server 350 may be of many different designs and may have different capabilities. Server 350 may include one more computers and may be of a special purpose design for processing data obtained from predictive readiness and accountability management.

User Device 310, 320, or 330 may include a device application to support predictive readiness and accountability management, for example, allowing a user to choose from different views or to add tasks. In another implementation, Device 310, 320, or 330 may display a website hosted on Server 350 in a browser, which may allow a user to request an action or input information. Server 350 may be operated by a party offering predictive readiness and accountability management. Server 350 may allow a user to receive a notification of the requested action.

An entity or individual may also provide a User Device 310, 320, or 330 to another entity or individual to provide access to a predictive readiness and accountability management system.

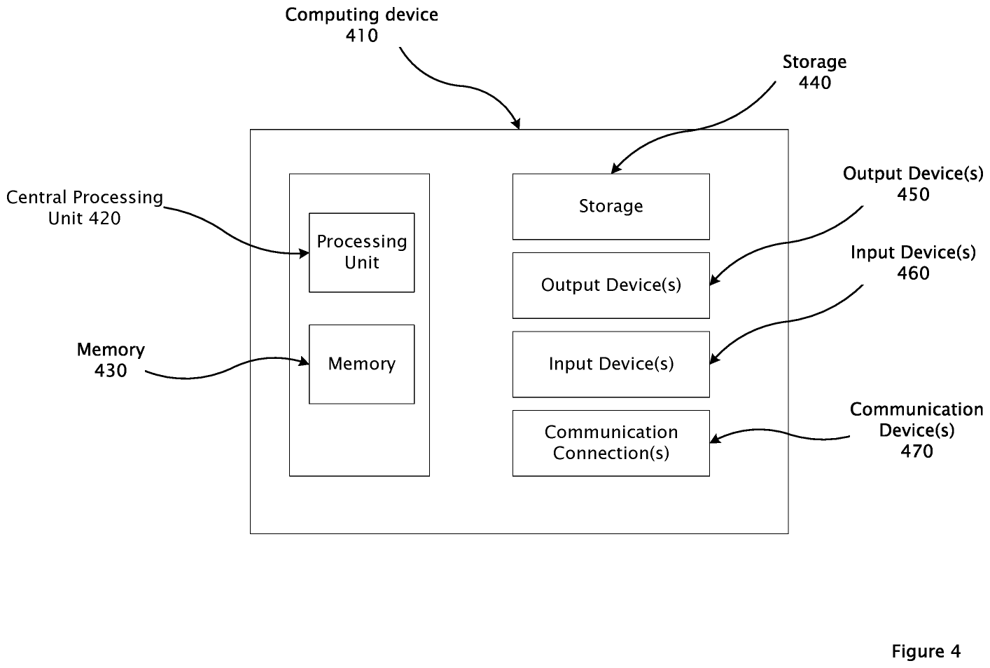

FIG. 4 is a component diagram of a Computing Device 410 configured to perform functions in accordance with an inventory and accountability tracking system, according to one implementation. Computing Device 410 can be utilized to implement one or more computing devices, computer processes, or software modules described herein, including, for example, but not limited to a mobile device. In one example, Computing Device 410 can be used to process calculations, execute instructions, and receive and transmit digital signals. In another example, Computing Device 410 can be utilized to process calculations, execute instructions, receive and transmit digital signals, receive and transmit search queries and hypertext, and compile computer code suitable for a mobile device. Computing Device 410 can be any general or special purpose computer now known or to become known capable of performing the steps or performing the functions described herein, either in software, hardware, firmware, or a combination thereof.

In its most basic configuration, Computing Device 410 typically includes at least one Central Processing Unit (CPU) 420 and Memory 430. Depending on the exact configuration and type of Computing Device 410, Memory 430 may be volatile (such as RAM), nonvolatile (such as ROM, flash memory, etc.), or some combination of the two. Additionally, Computing Device 410 may also have additional features/functionality. For example, Computing Device 410 may include multiple CPUs. The described methods may be executed in any manner by any processing unit in computing device 410. For example, the described process may be executed by both multiple CPUs in parallel.

Computing Device 410 may also include additional storage (removable or non-removable) including, but not limited to, magnetic or optical disks or tape. Such additional storage is illustrated by Storage 440. Computer-readable storage media includes volatile and nonvolatile, removable and non-removable media implemented in any method or technology for storage of information such as computer-readable instructions, data structures, program modules, or other data. Memory 430 and Storage 440 are all examples of computer-readable storage media. Computer-readable storage media may include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 410. Any such computer-readable storage media may be part of computing device 410. But computer-readable storage media does not include transient signals.

Computing Device 410 may also contain Communications Device(s) 470 that allow the device to communicate with other devices. Communications Device(s) 470 is an example of communication media. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. The term computer-readable media, as used herein, includes both computer-readable storage media and communication media. The described methods may be encoded in any computer-readable media in any form, such as data, computer-executable instructions, and the like.

Computing Device 410 may also have Input Device(s) 460, such as keyboard, mouse, pen, voice input device, touch input device, etc. Output Device(s) 450 such as a display, speakers, printer, etc. may also be included. All these devices are well known in the art and need not be discussed at length.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described implementations may be made without departing from the spirit and scope of the invention.

Additionally, the illustrated operations in the description show certain events occurring in a certain order. In alternative implementations, certain operations may be performed in a different order, modified or removed. Moreover, steps may be added to the above-described logic and still conform to the described implementations. Further, operations described herein may occur sequentially, or certain operations may be processed in parallel. Yet further operations may be performed by a single processing unit or by distributed processing units.

The foregoing description of various implementations of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many implementations of the invention can be made without departing from the spirit and scope of the invention, the invention resides in the claims hereinafter appended.

1. A method, comprising:
receiving an item identifier, the item identifier identifying an item;
receiving an accountable party identifier, the accountable party identifier identifying a person;
associating the item identifier to the accountable party identifier;
receiving an item geocode, the geocode identifying a location of the item, identifying a step or task in a project or workflow, or identifying a piece of data in a data stream;
receiving a first rule concerning the item or the person;
storing the item identifier, accountable party identifier, geocode, and the first rule in a database;
determining a second rule using machine learning; and
determining if the first rule or the second rule has been violated and, if so, transmitting an alert.

2. The method of claim 1 further comprising receiving advertisements or discounts for goods or services from third-party vendors.

3. The method of claim 1, wherein the item comprises a piece of equipment, an item of inventory, a task for a company project, or a piece of data.
